(19) United States
(12) Patent Application Publication
(10) Pub. No.: US 2025/0232305 A1
(43) Pub. Date: Jul. 17, 2025

(54) SYSTEMS AND METHODS FOR FRAUD PREVENTION IN REAL-TIME PROCESSING OF ELECTRONIC TRANSACTIONS

(71) Applicant: Capital One Services, LLC, McLean, VA (US)

(72) Inventors: Paul FORT, Westbury, NY (US); Jeffrey Carlyle WIEKER, Falls Church, VA (US); Jeffrey RULE, Chevy Chase, MD (US)

(21) Appl. No.: 18/414,621

(22) Filed: Jan. 17, 2024

(51) Int. Cl. G06Q 20/40

(52) U.S. Cl. CPC G06Q 20/4016; G06Q 20/4014

(57) ABSTRACT

Systems and methods are directed to an improved fraud detection feature in implementing online transaction. The proposed solution is based on generating an enhanced transaction verification request with access-device specific data parameters and merchant-provided data. The data is then converted into an XML format and integrated into the transaction verification. The account verification server, received the enhance transaction request and executes a risk assessment model based on the provided data parameters to compute a validity risk score for the transaction request, which in term informs the verification decision and subsequent messaging content transmitted back to the merchant system. Based on the computed risk score, the verification messaging can involve a direct validation, direct rejection or a delayed verification/rejection contingent upon secondary authentication data requested and received from the user and/or the merchant. The computed value of the risk score also determines the strength factor required for the secondary authentication data.

### FIELD OF THE DISCLOSURE

The present disclosure is generally related to electronic fraud detection, and more specifically to implementation of real-time risk assessment of online transactions.

### BACKGROUND

Existing systems and processes for online communication and processing of transactional data are optimized towards minimizing delay and streamlining the user experience. However, such optimization may involve a security trade-off with respect to detection and processing of fraudulent transactions that may be conducted with compromised financial/payment credentials.

These and other deficiencies exist. As such, there is need for an improved system and process directed to real-time implementation of transaction fraud detection and response automation that is both secure and accessible.

### SUMMARY OF THE DISCLOSURE

One aspect of the present disclosure is directed to a method for fraud mitigation in online transaction processing. The method may comprise steps corresponding, identifying, by a first process running on a merchant server, a plurality of contextual data elements associated with a transaction request received via a user interface application running on a user device, wherein the user interface application is associated with a corresponding server-side application running on the merchant server. The method may further comprise step for formatting the plurality of contextual data elements using an extensible mark-up language (XML), and generating a transaction verification request comprising a plurality of XML-formatted contextual data elements associated with the transaction request. The method may further comprise transmitting the transaction verification request to a second process executing on a verification server associated with a user account, computing, by the second process, a fraud risk score for the transaction request, based on the plurality of XML-formatted contextual data elements provided in the transaction verification request; and executing one or more actions by the verification server based on the risk score computed by the second process.

One aspect of the present disclosure is directed to a system for electronic transaction processing with real-time fraud prevention, the system comprising a computer hardware arrangement configure to: retrieve a plurality of purchase context data associated with a transaction request, wherein the transaction request is received, by a first process, via a user interface application running on a user device; generate a transaction verification request including the plurality of purchase context data, wherein the plurality of purchase context data are converted into an extensible mark-up language (XML) format prior to inclusion into the transaction verification request; compute a fraud risk score (FRS) for the transaction verification request using the plurality of XML-formatted purchase context data included in the transaction verification request, wherein the FRS is computed by a risk identification process executing on a verification server and communicatively coupled to the first process; and execute one or more verification actions, in response to the transaction request, based on the risk score computed by the risk identification process.

One Aspect of the present disclosure is directed to anon-transitory computer-accessible medium comprising instructions for execution by a computer hardware arrangement, wherein, upon execution of the instructions the computer hardware arrangement performs procedures comprising: identifying, by a first process running on a merchant server, a plurality of contextual data elements associated with a transaction request received via a user interface application running on a user device, wherein the user interface application is associated with a corresponding server-side application running on the merchant server; formatting the plurality of contextual data elements using an extensible mark-up language (XML); generating a transaction verification request comprising a plurality of XML-formatted contextual data elements; transmitting the transaction verification request to a second process executing on a verification server associated with a user account; computing, by the second process, a fraud risk score, for the transaction request, based on the plurality of XML-formatted contextual data elements provided in the transaction verification request; and executing one or more actions by the verification server based on the risk score computed by the second process.

### BRIEF SUMMARY OF THE DRAWINGS

FIG. 1A illustrates an exemplary process for generation of enhanced transaction request and a multi-tiered verification response, based on the computation of a transaction fraud risk score, in accordance with some embodiments of the present disclosure.

FIG. 1B illustrates an exemplary system implementation for generation of an enhanced transaction request and a multi-tiered verification response, based on the computation of a transaction fraud risk score, in accordance with some embodiments of the present disclosure.

FIG. 2 illustrates a exemplary implementation of a multi-tier verification response incorporating different gradation of step-up authentication implementation based on the risk score, in accordance with some embodiments of the present disclosure.

FIG. 3 illustrates an exemplary operational flow diagram for an improved implementation of real-time transaction fraud prevention, in accordance with some embodiments of the present disclosure.

FIG. 4 illustrated an exemplary block diagram of an exemplary system, in accordance with some embodiments of the present disclosure.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

Leveraging the ISO22002 standard for transmission of financial data, the present disclosure describes an improved online transaction processing and verification system and process which incorporates real-time fraud detection and multi-tier verification response automation. In accordance to one exemplary implementation, a first component of the described transaction processing system/process with real-time fraud prevention functionality corresponds a purchase context component (PCC) which executes on a merchant server/application and is configured to retrieve hardware and/or software information associated with a transaction-initiating device and/or mobile application. The PCC may also interact with other components of the merchant system to obtain purchase/item-related data (e.g., an item identifier, price, et.). The PCC or another related communication process, may then convert the retrieved data (e.g., device and merchant data) into an extensible mark-up language (XML) format and incorporate the XML-formatted purchase context data into a transaction verification request which may then be transmitted to a verification server associated with the transaction user account.

A second component of the described exemplary implementation (e.g., for a transaction processing system/process with real-time fraud prevention functionality) involves a risk identification component (RIC) executing on the verification server and communicatively coupled with the PCC (e.g., across a public and/or a private network connection). The RIC is configured to receives the purchase context data included in the transaction verification request and compute a fraud risk score (FRS) associated with the transaction request. RIC may use a machine-learning (ML) based data model for learning data patterns, associated with the purchase context data, that correspond to varying degrees of correlation with reported and/or identified transaction outcomes.

A multi-tiered verification process may then be implemented based on the computed FRS. In one example, a computed FRS value may be associated with a scale ranging from 0 to 1, wherein a FRS value of zero may imply a negligible risk of fraud and a FRS value of one may imply a very high likelihood that a transaction verification request is associated with a fraudulent transaction request. Automation of various verification actions (e.g., a multi-tiered verification response) may then be implemented in real-time based on a computed FRS value. In some embodiments, FRS-based verification actions may involve a request for a secondary authentication prior to verification of a transaction request enhanced with purchase context data. A verification response corresponding to a request for secondary authentication may be associated with FRS values that fall in between predetermined FRS thresholds for transaction approval and rejection. Such FRS values may be indicative of a moderate risk of fraud. In some embodiments, depending of the computed FRS value, the secondary authentication action may range from cryptographic verification of an encrypted authentication token, retrieved wirelessly from a user contactless card, (e.g., via s user mobile device) to plain-text verification of a one-time password (OTP) exchanged between the verification server and the user device.

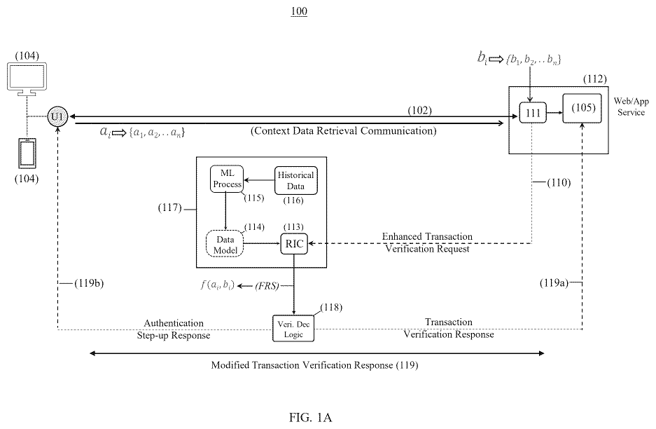

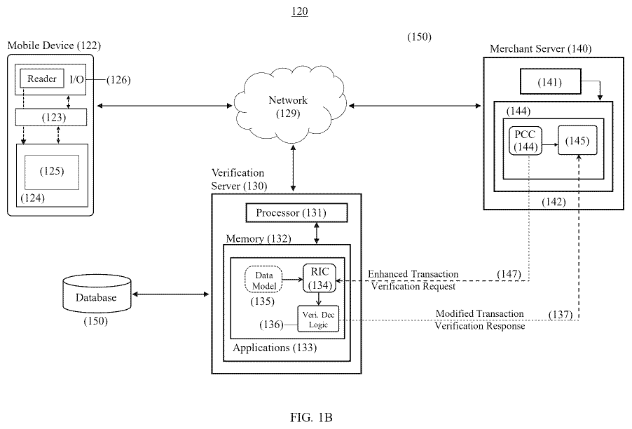

FIG. 1A illustrates an exemplary implementation of a transaction fraud prevention process based on internal operations and interactions of the PCC and RIC. The described implementation involves generation of an enhanced transaction verification request 110 (e.g., enhanced with purchase context data aᵢ and bᵢ as identified and retrieved by the PCC 111 executing as part of a merchant transaction processing application 112) and a computation of a fraud risk score (FRS), by a risk identification process (RIC) 113 as a function of the purchase context data associated with a transaction request. In example 100, the transaction request 102 may be initiated from a user device 104. In accordance to the illustrated example 100, the transaction request 102 maybe invoked via a user interface application U1 executing on a user device 104 in communication with a server-side merchant application/process 105 for transaction processing. In some embodiments, the user interface application U1 may correspond to a merchant website administered by a merchant web service 105 executing on a merchant server. In some embodiments, the user interface application U1 may correspond to a merchant mobile application stored on a user communication and/or computing device 104 and communicatively coupled with an application service 105 running on the merchant server.

Referring back to example 100, The purchase context data, or a portion thereof, may be retrieved via the user interface application (e.g., U1) running on the transaction-initiating user device (e.g., user device 104). The portion of purchase context data retrieved, by the PCC 111, via the user interface application may correspond to device and version identifiers associated with the user interface application and the user device. Purchase context data retrieved via the user interface application may also correspond to data retrieved by querying one or more mobile applications (e.g., geographical location data form a GPS application) executing on user device 104. In the exemplary embodiment 100, illustrated in FIG. 1A, the portion of the purchase context data retrieved from the user interface application U1 is indicated as data element aᵢ represented by data set {a₁, a₂, . . . aₙ}. PCC 111 may also communicate with other components of the merchant system to collect a set of merchant-related data (e.g., purchase item identifiers and pricing information) In the exemplary embodiment 100, illustrated in FIG. 1A, the portion of the purchase context data corresponding to merchant-related data, retrieved by PCC 111, is indicated by data elements bᵢ represented as a set of data values {b₁, b₂, . . . bₙ}. The purchase context data {aᵢ, bᵢ} may then be converted into XML format and included in a transaction verification request 110, which may be communicated via the Web/Application service 105, to a second component of the transaction fraud prevention process (e.g., RIC executing as part of a remote verification process 117, associated with the user account).

As shown in example 100, RIC 113 receives the purchase context data (aᵢ, bᵢ), included in the enhanced transaction verification request 110, and compute a fraud risk or probability score (e.g., FRS), for the transaction request 102, as a function of the purchase context data (e.g., aᵢ and bᵢ). As shown in FIG. 1A, the FRS computation process may be aided by a fraud assessment data model 114. In some embodiments the fraud assessment model 114 may be generated and trained by one or more machine-learning processes/routines 115 using historical transactional data associated with various patterns and sets of purchase context data {aᵢ, bᵢ}.

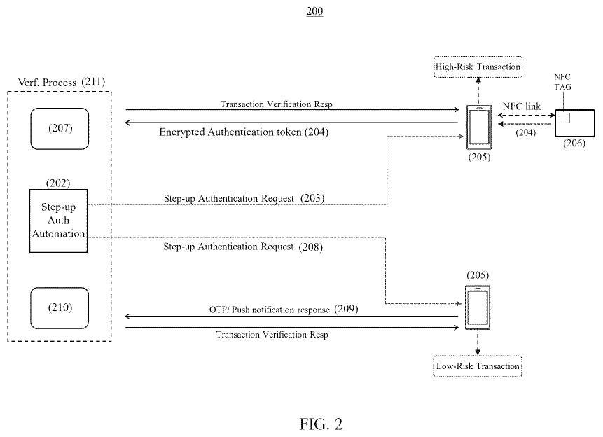

Referring back to FIG. 1A, the FRS value computed by the RIC 113 may be processed by a verification decision logic 118 for generation of a modified or multi-tier verification response based on the received FRS value associated with the transaction request (e.g., 102). As shown in FIG. 1A, the modified/multi-tier transaction verification response 119 may comprise distinct modes as determined by the transaction FRS value. The modified transaction verification response may be initiated as a transaction approval or transaction rejection message 119a. In some embodiments, various range of the FPS may trigger a distinct response mode corresponding to an authentication step-up response 109b, which may be transmitted to the user device 104 (e.g., for provision of a secondary authentication response), as shown in FIG. 1A. As further illustrated in FIG. 2, the authentication step-up response may have different strength gradation requirements based on the computed FRS value.

FIG. 1B illustrates an exemplary system implementation 120 for the enhanced transaction processing scheme illustrated in FIG. 1A. The example system implementation 120 comprises, an online transaction-initiating device, represented by a user communication device 122, a verification server 124 associated, for example, with a user financial account, a network 130 and a database 150. Although FIG. 1B illustrates single instances of components of system 120, system 120 may include any number of components.

Referring back to example 120, user communication device 122, may include one or more processors 123 (e.g., one or more microprocessors), coupled to memory 124, which may be, for example, random access memory (RAM), read-only memory (ROM), programmable read-only memory (PROM), erasable programmable read-only memory (EPROM), and/or electrically erasable programmable read-only memory (EEPROM), and the user communication device 122 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

Memory 124 may include one or more applications 125, for example a mobile web browser with one or more browser extension (e.g., WebNFC) and a payment applications, as well as software components for facilitating wireless communication with other wireless-enabled devices, ands network communication, via a network 129, with one or more remote servers (e.g., verification server 130 and/or merchant server 140). The processor 123 may be a processor, a microprocessor, or other processor, and the user communication device 122 may include one or more of these processors. The processor 123 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The User communication device 122 may further include one or more Input/Output (I/O) devices 126 for capturing user inputs and displaying one or more information records and/or notification messages to the user. For example, I/O devices 126 may include at least one display and input device. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user (communication) device that is available and supported by the device, such as a touch-screen, keyboard, mouse, cursor-control device, touch-screen, microphone, digital camera, video recorder or camcorder.

I/O devices 126, associated with the user communication device 122, may include an electronic reader unit 127 for capturing information via one or more short range wireless transmissions. The user communication device 122 may correspond to a network-enabled computer device, with a network communication interface. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other network-enabled computing or communications devices. For example, network-enabled computing devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. It is further understood that the user (communication) device may be of any type of device that supports the communication and display of data and user input. The present disclosure is not limited to a specific number of user devices, and it is understood that the system 120 may include a single client device or multiple client devices.

Referring back to FIG. 1, a transaction initiated from the user device 122, using a mobile application 125, may be communicated to the merchant server 140. The merchant server 140, as illustrated in FIG. 1B may comprise a processor 141 communicatively coupled to a memory 142. The memory 143 may comprise one or more applications 144, such as a server-side web application and/or one or more payment processing applications (collectively represented as element 145), for communication with a mobile browser application and/or one or more client-side payment application 125 running on the user communication device 122 and invoked by a user for conducting an online transaction directed to, for example, merchant server 140.

As described above, an exemplary implementation of the transaction fraud prevention system (FPS) may comprise two operational component including a purchase context component (PCC), for real-time acquisition of purchase context data during initiation of a transaction with a merchant system (e.g., merchant server 140), and a risk identification component (RIC) for evaluation of a fraud probability (e.g., computation of a fraud risk score) as a function of the purchase context data. As shown in exemplary implementation 120, PCC 146 stored on the merchant server 140 may be invoked by the server processor 141 for facilitating the retrieval of purchase context data which may then be communicated to the one or more payment processing and/or web service components (e.g., applications 145) running on the merchant server 140. Using the purchase context data, an enhanced transaction verification request 147 which includes the purchase context data may be generated by the merchant server and transmitted to a verification server 130 (e.g., user account issuing server).

As shown in the exemplary system implementation 120, illustrated in FIG. 1B, The verification server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The verification server 130 may include a processor 131, a memory 132 storing one or more applications 133. The processor 131 may be a processor, a microprocessor, or other processor, and the verification server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the verification server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as a set of software routines and applications 133, and other data, such as user's private data and financial account information.

The applications 133 may comprise one or more software applications comprising instructions for execution on the server 130. In some examples, the verification server 130 may execute one or more applications, such as software applications, that enable, for example, network communications with one or more components of the system 120, transmit and/or receive data, and perform the functions described herein. Upon execution by the processor 131, the application 133 may provide the functions described in this specification, specifically to execute and perform the steps and functions for automating a modified transaction verification process. The modified transaction verification process may be based on an assessment of fraud probability for an incoming transaction verification request enhanced with purchase context data (e.g., enhanced transaction verification request 147 facilitated by PCC 144 running on the merchant server 140). For example, applications 133 may store a risk identification component (RIC) 134 communicatively coupled to the PCC, and configured to generate a fraud risk score (FRS) as a function of the purchase context data. The RIC computation of a fraud risk score from the purchase context data (e.g., extracted from an incoming enhanced transaction verification request) may be aided by a ML-based data model 135 trained on fraud patterns associated with various combinations/iterations and values of purchase context data. The application 133 may further comprise a verification decision logic 136 for automating generation of a modified verification response 137 based on an evaluation of the FRS received from the RIC. Such processes may be implemented in software, such as software modules, for execution by computers or other machines. The application 133 may provide GUIs through which a user may view and interact with other components and devices within the system 120. The GUIs may be formatted, for example, as web pages in HyperText Markup Language (HTML), Extensible Markup Language (XML) or in any other suitable form for presentation on a display device depending upon applications used by users to interact with the system 120.

The verification server 120 may further include a display and input devices (not shown). The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the verification server 130 that can be available and supported by the verification server 130, such as a touch-screen, keyboard, mouse, cursor-control device, touch-screen, microphone, digital camera, video recorder or camcorder. These devices may be used to enter information and interact with the software and other devices described herein.

System 120 may include one or more networks 129. In some examples, the network 129 may be one or more of a wireless network, a wired network or any combination of wireless network and wired network, and may be configured to connect the user devices (e.g., user communication device 122), the verification server 130, the merchant server 140 and the database 150. For example, the network 129 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 129 may include, without limitation, telephone lines, fiber optics, IEEE Ethernet 902.3, a wide area network, a wireless personal area network, a LAN, or a global network such as the Internet. In addition, the network 129 may support an Internet network, a wireless communication network, a cellular network, or the like, or any combination thereof. The network 129 may further include one network, or any number of the exemplary types of networks mentioned above, operating as a stand-alone network or in cooperation with each other. The network 129 may utilize one or more protocols of one or more network elements to which they are communicatively coupled. The network 129 may translate to or from other protocols to one or more protocols of network devices. Although the network 129 is depicted as a single network, it should be appreciated that according to one or more examples, the network 129 may comprise a plurality of interconnected networks, such as, for example, the Internet, a service provider's network, a cable television network, corporate networks, such as credit card association networks, and home networks. The network 129 may further comprise, or be configured to create, one or more front channels, which may be publicly accessible and through which communications may be observable, and one or more secured back channels, which may not be publicly accessible and through which communications may not be observable.

System 120 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the verification server 130 or may be hosted externally of the verification server 130, such as by a server, by a cloud-based platform, or in any storage device that is in data communication with the verification server 130.

In some examples, exemplary procedures in accordance with the present disclosure described herein can be performed by a processing arrangement and/or a computing arrangement (e.g., a computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the user device 122, the verification server 130, the merchant server 140, the network 129, and the database 150 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

FIG. 2 illustrates an exemplary implementation 200 for automation of a authentication step-up communication generated by an automation module 202 which incorporates different gradation of step-up authentication request based on the computed FRS value. For example, according to the illustrated embodiment 200, the FRS-moderated authentication step-up request 203, generated by the automation module 202, may correspond to a validation of an encrypted authentication password/token 204 retrieved, via a user device 205 from a contactless card 206. In accordance to the illustrated embodiment 200, validation of encrypted token 204, generated in response to step-authentication request 203, may be performed by a verification operation 207 associated with higher risk transactions. The verification operation 207 may be executing as part of the remote verification process 211 associated with one or more relevant user financial accounts.

Example 200 of FIG. 2, further illustrates a FRS-moderated authentication step-up request 208, generated by the automation module 202, for lower risk transactions. The authentication step-up request 208 may involve a validation of a OTP and/or push notification 209 exchanged between a verification operation 210, executing as part of the remote verification process 211, and the user device 205.

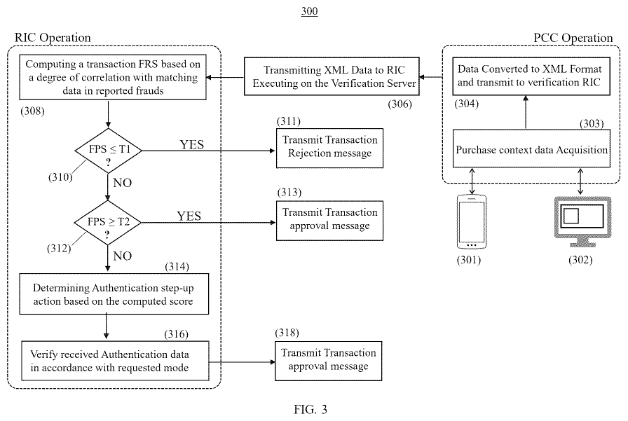

FIG. 3 illustrates an exemplary operational flow diagram for an improved implementation of a transaction fraud prevention system (FPS) for facilitating a secure real-time processing of electronic transactions. Exemplary operation of the transaction fraud prevention system (FPS) may start at step 303 wherein purchase context data, that may be used in transaction risk assessment, is retrieved by the PCC portion of the transaction fraud prevention system (FPS). As illustrated in step 303, purchase context data may be acquired by a purchase context data acquisition process and/or component (e.g., PCC) running on a transaction-receiving system such as a merchant application and/or web server. One component of the purchase context data, retrieved by the PCC, may comprise a number of data elements retrieved from a user transaction-initiating device such a mobile communication device 301 and/or a computing device 302.

As described above, the retrieval of data from the transaction-initiating device may be facilitated by the PCC executing on the transaction-receiving device, such as a merchant system. The PCC may further retrieve merchant and/or item related data via communication with one or more components of the merchant system. At step 304, the data retrieved by the PCC may be converted to an extensible mark-up language (e.g., XML) format and transmitted to a to a second component of the transaction fraud prevention system (FPS) corresponding to a risk identification component (RIC) that may be executing on a verification server associated with a user account. The conversion of the purchase context data into an XML format may be facilitated by the PCC or a distinct process communicatively coupled thereto.

Upon receiving the XML-formatted purchase context data (e.g., via a public/private network connection with the merchant system running the PCC), the risk identification component (RIC), my compute a transaction fraud risk score (FRS) for the incoming enhanced transaction request (e.g., transaction request comprising the purchase context data retrieved by PCC), as shown in step 308. The risk assessment/identification process may incorporate a fraud assessment data model trained on previously retrieved purchase context data for a set of transactions with a resolved validity and/or fraud status (e.g., transactions, including purchase context data, previously established as either valid or fraudulent). In some embodiments, a machine-learning process may be used to continuously train the fraud assessment data model using archived and/or real-time data associated with purchase context data and transaction validity status provided by a user and/or a fraud data repository.

At step 310 the computed fraud risk score (FRS) is evaluated to determine its value with respect to a first threshold range T1 (e.g., a first fraud probability value range). In accordance to the exemplary embodiment 300, an FPS value in excess of T1, corresponding to a high probability of a fraudulent transaction, may initiate a rejection of the received transaction request, in which case a transaction rejection message may be transmitted back to the merchant system, as shown in step 311.

Referring back to the example flow diagram 300, if an FRS value exceeds the T1 threshold value (as determined during step 310), the FRS value may be further evaluated with respect to a second threshold value T2, as shown in step 312. An FRS value that is equal or greater than T2, corresponding to a low probability of fraudulent transaction (e.g., high probability that the received transaction message is valid), may initiate an approval of the received transaction request, in which case a transaction approval message may be transmitted back to the merchant system, as shown in step 313.

In accordance to the exemplary embodiment 300, an FPS value that is less than T1 but greater than T2 (e.g., {T2>FRS>T1}) may correspond to a moderate probability of a fraudulent transaction, based on analysis of the purchase context data. With reference to the example flow diagram 300, a determination of a moderate fraud probability at step 312, may initiate an authentication step-up request, transmitted by the verification server, to one or more electronic devices associated with the user. As shown in step 314, the content and context (e.g., a strength factor) of the authentication step-up action executed by the verification server (e.g., a transaction verification logic based on a computed FPS value) may be determined based on the value of the computed transaction FPS within a range of values corresponding to a moderate probability of a fraudulent transaction (e. g., {T2>FRS>T1}).

In accordance to some embodiments, an FRS value closer to the high end of the range (associated with the moderate fraud probability) may initiate a strong authentication step-up action. One implementation of a strong authentication step-up action may correspond to a request message for retrieval, by the user device, of an encrypted authentication token stored on a user contactless smart card with a near-field communication (NFC) interface/tag. An NFC reader (internal or external to the user device) may be used to read and communicate the encrypted authentication token from the user contactless card to an authentication process running on the verification server. A successful validation of the authentication token may then initiate an approval of the received (enhanced) transaction validation request, in which case a transaction approval message may be transmitted back to the merchant system, as shown in step 318.

In accordance to some embodiments, an FRS value closer to the low end of the range (associated with the moderate fraud probability) may initiate a weaker but faster authentication step-up action on a part of the FRS-based verification logic. One implementation of a weaker authentication step-up action may correspond to a transmission of a one-time password (OTP) by the verification server to a mobile and/or computing device associated with the user (e.g., financial account holder used in conducting the transaction) A successful validation of the OTP, transmitted, by the user device back to the verification server may then initiate an approval of the received (enhanced) transaction validation request, in which case a transaction approval message may be transmitted back to the merchant system, (e.g., step 318).

As discussed above, the exemplary system, method and computer-accessible medium can utilize machine learning to compute a set of optimally scaled purchase context parameters and data values. The exemplary machine learning can utilize information from reported fraud data and historical transactions with corresponding set of purchase context data values to make the determination, and various exemplary models can be generated (e.g., for computing trends in user transactional and behavioral patterns, as well as risk factor predictions based on the computed trends). The exemplary system, method and computer-accessible medium can then apply the generated models to effectively compute a fraud probability associated with an online transaction and accordingly modify a corresponding verification decision and a subsequent verification response transmitted to the verification requesting merchant system and/or transaction-initiating user device.

The fraud data model described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The exemplary system, method and computer-accessible medium can utilize various neural networks, such as convolutional neural networks (CNNs) or recurrent neural networks (RNNs), to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (“LSTMs”) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training datasets can include previous predictions for the instant system and other types of system, and may further include results data indicative of the accuracy of the previous predictions. In accordance with these examples, the predictive models described herein may be trained prior to use and the training may continue with updated data sets that reflect additional information.

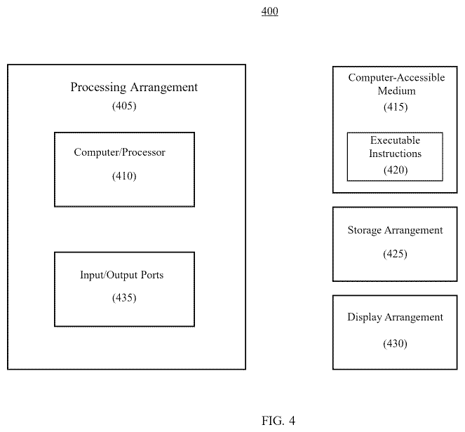

FIG. 4 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement 405 that may be configured for predictive computation of a valid device enrollment probability, associated with a MAV enrollment request, and automation of an enrollment response, accordingly). Such processing and/or computing arrangement 405 can be, for example entirely or a part of, or include, but not limited to, a computer and/or processor 410 that can include, for example one or more microprocessors, and use instructions stored on a computer-accessible medium (e.g., RAM, ROM, hard drive, or other storage device).

As shown in FIG. 4, for example a computer-accessible medium 415 (e.g., as described herein above, a storage device such as a hard disk, floppy disk, memory stick, CD-ROM, RAM, ROM, etc., or a collection thereof) can be provided (e.g., in communication with the processing arrangement 405). The computer-accessible medium 415 can contain executable instructions 420 thereon. In addition or alternatively, a storage arrangement 425 can be provided separately from the computer-accessible medium 415, which can provide the instructions to the processing arrangement 405 so as to configure the processing arrangement to execute the exemplary procedures, processes, and methods, as described herein above, for example.

Further, the exemplary processing arrangement 405 can be provided with or include an input and/or output ports 435, which can include, for example a wired network, a wireless network, the internet, an intranet, a data collection probe, a sensor, etc. As shown in FIG. 4, the exemplary processing arrangement 405 can be in communication with an exemplary display arrangement 430, which, according to certain exemplary embodiments of the present disclosure, can be a touch-screen configured for inputting information to the processing arrangement in addition to outputting information from the processing arrangement, for example. Further, the exemplary display arrangement 430 and/or a storage arrangement 425 can be used to display and/or store data in a user-accessible format and/or user-readable format.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

Systems and methods described herein can provide secure, retrieval of sensitive user information or enabling streamlined communication and processing of sensitive user information for example, for facilitating secure electronic transactions. Once a valid authorization response from an authenticated user has been established, the automated data retrieval and transfer systems and processes can permit, without limitation, financial transactions (e.g., credit card and debit card transactions), account management transactions (e.g., card refresh, card replacement, and new card addition transactions), membership transactions (e.g., joining and departing transactions), point of access transactions (e.g., building access and secure storage access transactions), transportation transactions (e.g., ticketing and boarding transactions), and other transactions

In some aspects, the techniques described herein relate to a method for fraud mitigation in online transaction processing, the method including: identifying, by a first process running on a merchant server, a plurality of contextual data elements associated with a transaction request received via a user interface application running on a user device, wherein the user interface application is associated with a corresponding server-side application running on the merchant server; formatting the plurality of contextual data elements using an extensible mark-up language (XML); generating a transaction verification request including a plurality of XML-formatted contextual data elements associated with the transaction request; transmitting the transaction verification request to a second process executing on a verification server associated with a user account; computing, by the second process, a fraud risk score for the transaction request, based on the plurality of XML-formatted contextual data elements provided in the transaction verification request; and executing one or more actions by the verification server based on the risk score computed by the second process.

In some aspects, the techniques described herein relate to a method, wherein the plurality of contextual data elements associated with a transaction request correspond to a first purchase context data retrieved from the user interface application, running on the user device, and a second purchase context data retrieved from the server-side application, running on the merchant server.

In some aspects, the techniques described herein relate to a method, wherein the first purchase context data retrieved from the user interface application includes one or more identifier and version related data associated with the user interface application.

In some aspects, the techniques described herein relate to a method, wherein the first purchase context data retrieved from the user interface application further includes, a device geographical location data, and one or more device fingerprint data including a device screen resolution and aspect ratio.

In some aspects, the techniques described herein relate to a method, wherein the second purchase context data retrieved from the server-side application running on the merchant server includes one or more identifier and version related data associated with the server-side application.

In some aspects, the techniques described herein relate to a method, wherein the second purchase context data retrieved from the server-side application further includes, one or more attributes associated with a purchase item corresponding to the transaction request.

In some aspects, the techniques described herein relate to a method, wherein the one or more actions executed by the verification server based on the risk score includes a transmission of a rejection message in response to the transaction verification request, if the computed risk score is less than a first predetermined threshold value.

In some aspects, the techniques described herein relate to a method, wherein the one or more actions executed by the verification server, based on the risk score, includes a transmission of an approval message in response to the transaction verification request, if the computed risk score exceeds a second predetermined threshold value.

In some aspects, the techniques described herein relate to a method, wherein the one or more actions executed by the verification server, based on the risk score, includes a request for a secondary authentication if the computed risk score is greater than the first predetermined threshold value and less than the second predetermined threshold value.

In some aspects, the techniques described herein relate to a method, wherein an authentication strength factor associated with the request for the secondary authentication is determined, by the verification server, based on a value of the computed risk factor.

In some aspects, the techniques described herein relate to a method, wherein a strong secondary authentication factor corresponds to a validation of an encrypted authentication token wirelessly retrieved, via the user device, from a contactless card associated with the user.

In some aspects, the techniques described herein relate to a method, wherein a weak secondary authentication factor corresponds to a validation of a one-time-password transmitted, by the user device, to the verification server.

In some aspects, the techniques described herein relate to a method, wherein a computation of the fraud risk score by the second process is based on a fraud assessment data model, wherein a set of model parameters, associated with the fraud assessment data model, include the plurality of purchase context data,

In some aspects, the techniques described herein relate to a method, wherein the fraud assessment data model is trained on data associated with a plurality of resolved transaction outcomes and corresponding sets of purchase context data.

In some aspects, the techniques described herein relate to a system for electronic transaction processing with real-time fraud prevention, the system including a computer hardware arrangement configure to: retrieve a plurality of purchase context data associated with a transaction request, wherein the transaction request is received, by a first process, via a user interface application running on a user device; generate a transaction verification request including the plurality of purchase context data, wherein the plurality of purchase context data are converted into an extensible mark-up language (XML) format prior to inclusion into the transaction verification request; compute a fraud risk score (FRS) for the transaction verification request using the plurality of XML-formatted purchase context data included in the transaction verification request, wherein the FRS is computed by a risk identification process executing on a verification server and communicatively coupled to the first process; and execute one or more verification actions, in response to the transaction request, based on the risk score computed by the risk identification process.

In some aspects, the techniques described herein relate to a system, wherein the plurality purchase context data associated with the transaction request includes a first data portion retrieved from the user interface application, running on the user device, and a second data portion retrieved from a server-side application associated with the user interface application.

In some aspects, the techniques described herein relate to a system, wherein the first data portion retrieved from the user interface application includes one or more identifier and version related data associated with the user interface application and the user device.

In some aspects, the techniques described herein relate to a system, wherein the second data portion retrieved from the server-side application includes one or more identifier and version related data associated with the server-side application and one or more purchase items corresponding to the transaction request.

In some aspects, the techniques described herein relate to a system, wherein the one or more verification actions, executed based on a computed risk score, include; generation of a rejection message in response to the transaction verification request, if the computed risk score is less than a first predetermined threshold value; generation of an approval message in response to the transaction verification request, if the computed risk score exceeds a second predetermined threshold value; and generation of a request message for a secondary authentication if the computed risk score is greater than the first predetermined threshold value and less than the second predetermined threshold value.

In some aspects, the techniques described herein relate to a non-transitory computer-accessible medium including instructions for execution by a computer hardware arrangement, wherein, upon execution of the instructions the computer hardware arrangement performs procedures including: identifying, by a first process running on a merchant server, a plurality of contextual data elements associated with a transaction request received via a user interface application running on a user device, wherein the user interface application is associated with a corresponding server-side application running on the merchant server; formatting the plurality of contextual data elements using an extensible mark-up language (XML); generating a transaction verification request including a plurality of XML-formatted contextual data elements; transmitting the transaction verification request to a second process executing on a verification server associated with a user account; computing, by the second process, a fraud risk score, for the transaction request, based on the plurality of XML-formatted contextual data elements provided in the transaction verification request; and executing one or more actions by the verification server based on the risk score computed by the second process.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of duser devicata storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method for fraud mitigation in online transaction processing, the method comprising:
identifying, by a first process running on a merchant server, a plurality of contextual data elements associated with a transaction request received via a user interface application running on a user device, wherein the user interface application is associated with a corresponding server-side application running on the merchant server;
formatting the plurality of contextual data elements using an extensible mark-up language (XML);
generating a transaction verification request comprising a plurality of XML-formatted contextual data elements associated with the transaction request;
transmitting the transaction verification request to a second process executing on a verification server associated with a user account;
computing, by the second process, a fraud risk score for the transaction request, based on the plurality of XML-formatted contextual data elements provided in the transaction verification request; and
executing one or more actions by the verification server based on the risk score computed by the second process.

2. The method of claim 1, wherein the plurality of contextual data elements associated with a transaction request correspond to a first purchase context data retrieved from the user interface application, running on the user device, and a second purchase context data retrieved from the server-side application, running on the merchant server.

3. The method of claim 2, wherein the first purchase context data retrieved from the user interface application comprises one or more identifier and version related data associated with the user interface application.

4. The method of claim 3, wherein the first purchase context data retrieved from the user interface application further comprises, a device geographical location data, and one or more device fingerprint data comprising a device screen resolution and aspect ratio.

5. The method of claim 2, wherein the second purchase context data retrieved from the server-side application running on the merchant server comprises one or more identifier and version related data associated with the server-side application.

6. The method of claim 5, wherein the second purchase context data retrieved from the server-side application further comprises, one or more attributes associated with a purchase item corresponding to the transaction request.

7. The method of claim 1, wherein the one or more actions executed by the verification server based on the risk score comprises a transmission of a rejection message in response to the transaction verification request, if the computed risk score is less than a first predetermined threshold value.

8. The method of claim 1, wherein the one or more actions executed by the verification server, based on the risk score, comprises a transmission of an approval message in response to the transaction verification request, if the computed risk score exceeds a second predetermined threshold value.

9. The method of claim 1, wherein the one or more actions executed by the verification server, based on the risk score, comprises a request for a secondary authentication if the computed risk score is greater than a first predetermined threshold value and less than a second predetermined threshold value.

10. The method of claim 9, wherein an authentication strength factor associated with the request for the secondary authentication is determined, by the verification server, based on a computed value of the risk score.

11. The method of claim 10, wherein a strong secondary authentication factor corresponds to a validation of an encrypted authentication token wirelessly retrieved, via the user device, from a contactless card associated with the user.

12. The method of claim 10, wherein a weak secondary authentication factor corresponds to a validation of a one-time-password transmitted, by the user device, to the verification server.

13. The method of claim 1, wherein a computation of the fraud risk score by the second process is based on a fraud assessment data model, wherein a set of model parameters, associated with the fraud assessment data model, comprise a plurality of purchase context data.

14. The method of claim 13, wherein the fraud assessment data model is trained on data associated with a plurality of resolved transaction outcomes and corresponding sets of purchase context data.

15. A system for electronic transaction processing with real-time fraud prevention, the system comprising a computer hardware arrangement configure to:
retrieve a plurality of purchase context data associated with a transaction request, wherein the transaction request is received, by a first process, via a user interface application running on a user device;
generate a transaction verification request including the plurality of purchase context data, wherein the plurality of purchase context data are converted into an extensible mark-up language (XML) format prior to inclusion into the transaction verification request;
compute a fraud risk score (FRS) for the transaction verification request using a plurality of XML-formatted purchase context data included in the transaction verification request, wherein the FRS is computed by a risk identification process executing on a verification server and communicatively coupled to the first process; and
execute one or more verification actions, in response to the transaction request, based on the risk score computed by the risk identification process.

16. The system of claim 15, wherein the plurality purchase context data associated with the transaction request comprises a first data portion retrieved from the user interface application, running on the user device, and a second data portion retrieved from a server-side application associated with the user interface application.

17. The system of claim 16, wherein the first data portion retrieved from the user interface application comprises one or more identifier and version related data associated with the user interface application and the user device.

18. The system of claim 16, wherein the second data portion retrieved from the server-side application comprises one or more identifier and version related data associated with the server-side application and one or more purchase items corresponding to the transaction request.

19. The system of claim 15, wherein the one or more verification actions, executed based on a computed risk score, comprise;
generation of a rejection message in response to the transaction verification request, if the computed risk score is less than a first predetermined threshold value;
generation of an approval message in response to the transaction verification request, if the computed risk score exceeds a second predetermined threshold value; and
generation of a request message for a secondary authentication if the computed risk score is greater than the first predetermined threshold value and less than the second predetermined threshold value.

20. A non-transitory computer-accessible medium comprising instructions for execution by a computer hardware arrangement, wherein, upon execution of the instructions the computer hardware arrangement performs procedures comprising:
identifying, by a first process running on a merchant server, a plurality of contextual data elements associated with a transaction request received via a user interface application running on a user device, wherein the user interface application is associated with a corresponding server-side application running on the merchant server;
formatting the plurality of contextual data elements using an extensible mark-up language (XML);
generating a transaction verification request comprising a plurality of XML-formatted contextual data elements;
transmitting the transaction verification request to a second process executing on a verification server associated with a user account;
computing, by the second process, a fraud risk score, for the transaction request, based on the plurality of XML-formatted contextual data elements provided in the transaction verification request; and
executing one or more actions by the verification server based on the risk score computed by the second process.
